(19) United States
(12) Patent Application Publication
(10) Pub. No.: US 2009/0070194 A1
(43) Pub. Date: Mar. 12, 2009

(54) METHOD OF PROVIDING ESTIMATED COST FOR KEYWORD ADVERTISEMENT

(75) Inventor: KI HO SONG, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 12/204,687

(22) Filed: Sep. 4, 2008

(30) Foreign Application Priority Data
Sep. 6, 2007 (KR) 10-2007-0090537

(51) Int. Cl. G06Q 30/00; G06F 17/30

(52) U.S. Cl. 705/10; 707/5; 705/14; 707/E17.017

(57) ABSTRACT

Disclosed is a method of running a keyword advertisement service. The method comprises receiving, from a potential advertiser, a proposed cost-per-click (proposed CPC) for a first keyword advertisement using a first keyword, providing historical data of a count of search queries submitted to the search engine and comprising the first keyword, and providing historical data of click-through-rates (CTRs) of keyword advertisement contents arranged in a first one of the plurality of groups of keyword advertisements. The method further comprises computing a first estimated cost for using the keyword advertisement service with regard to the first keyword advertisement for a future period of time, wherein computing uses the proposed CPC, historical data of a count of search queries and historical data of CTRs.

### CROSS-REFERENCE TO RELATED APPLICATION

This application claims the benefit of Korean Patent Application No. 10-2007-0090537, filed on Sep. 6, 2007, in the Korean Intellectual Property Office, the disclosure of which is incorporated herein by reference in its entirety.

### BACKGROUND

1. Field

The present disclosure relates to a keyword advertisement service, and more particularly, to computing an estimated cost for a keyword advertisement.

2. Discussion of Related Technology

A keyword advertisement denotes a type of advertisement that can display advertisements in a search result page when advertisers purchase a particular keyword and then a user searches for a desired advertisement using a search word including the keyword. For example, when the user enters a keyword associated with “relocation” for searching, advertisements associated with “packing relocation”, “relocation help center”, and the like are retrieved. In this instance, in an aspect that an advertisement is displayed for only a person interested in a particular product or item, the keyword advertisement is different from an existing banner advertisement. Specifically, since the advertisement is exhibited for only the person that has interest in the particular product or the item, it is possible to improve the target advertising effect and a click rate.

The keyword advertisement includes cost-per-click (CPC) advertisement and a cost-per-mill (CPM) advertisement. In the CPC advertisement, regardless of a number of displays after searching, only when a user clicks on a corresponding advertisement is an advertiser charged. Specifically, the advertiser deposits a predetermined amount of money in advance. Only when an advertisement is displayed at search results of an associated keyword and a user is connected to a linked site through clicking on the advertisement is a cost per click deducted from the deposited money. In the CPM advertisement, a flat sum is set with respect to an ongoing advertisement of a predetermined period of time and the advertiser is charged up to the flat sum regardless of any clicks on the advertisement.

The foregoing discussion in the background section is to provide general background information, and does not constitute an admission of prior art.

### SUMMARY

One aspect of the invention provides a method of running a keyword advertisement service. The method comprises: providing a keyword advertisement service, which posts keyword advertisement contents in a search result generated in response to a search query submitted to a search engine and charges for the service based on clicking through on the keyword advertisement contents, wherein the keyword advertisement contents are arranged in a plurality of groups in a display of the search result; receiving, from a potential advertiser, a proposed cost-per-click (proposed CPC) for a first keyword advertisement using a first keyword; providing historical data of a count of search queries submitted to the search engine and comprising the first keyword; providing historical data of click-through-rates (CTRs) of keyword advertisement contents arranged in a first one of the plurality of groups; and computing a first estimated cost for using the keyword advertisement service with regard to the first keyword advertisement for a future period of time, wherein computing uses the proposed CPC, historical data of a count of search queries and historical data of CTRs.

The foregoing method may further comprise: providing the first estimated cost to the potential advertiser; and receiving, from the potential advertiser, a request for arranging a content of the first keyword advertisement in the first group in displaying search results in reply to search queries comprising the first keyword. The foregoing method may further comprise: requesting, to the potential advertiser, for making a prepayment for using the keyword advertisement service with regard to the first keyword advertisement; and receiving the prepayment. The foregoing method may further comprise: computing a proposed prepayment amount using the first estimated cost; and providing the potential advertiser with the proposed prepayment amount.

Still in the foregoing method, computing the first estimated cost may comprise processing historical data of the count of search queries to provide an average count of search queries for a past period of time. The average count may be one selected from the group consisting of a daily average, a bi-daily average, a weekly average, a bi-weekly average, a monthly average, a quarterly average, and an hourly average of the count of search queries. Providing the historical data of CTRs of keyword advertisements arranged in the first group may comprise: identifying keyword advertisements, contents of which were or have been ever arranged in the first group for a past period time; and providing a CTR of each of the identified keyword advertisements for the past period of time. Computing the first estimated cost may comprise processing the CTRs of the keyword advertisements to provide an average CTR of the identified keyword advertisements.

Yet in the foregoing method, the method may further comprise: rendering the keyword advertisement service with regard to the first keyword advertisement; and computing a charge for the keyword advertisement service with regard to the first keyword advertisement using a cost-per-click that is equal to or smaller than the proposed CPC. The method may further comprise: rendering the keyword advertisement service with regard to the first keyword advertisement, wherein the content of the first keyword advertisement is arranged in the first group in search results generated in response to search queries comprising the first keyword.

Further in the foregoing method, the method may further comprise: providing second historical data of click-through-rates (CTRs) of keyword advertisements arranged in a second one of the plurality of groups; and computing a second estimated cost for using the keyword advertisement service with regard to the first keyword advertisement for a future period of time, wherein computing uses the proposed CPC, historical data of a count of search queries and second historical data of CTRs. The method may further comprise: providing the second estimated cost to the potential advertiser; and receiving, from the potential advertiser, a request for arranging the content of the first keyword advertisement in the first group in displaying search results in reply to search queries comprising the first keyword. The keyword advertisement service may have different service fee structures for at least two of the plurality of groups.

Another aspect of the invention provides a method of subscribing a keyword advertisement service. The method comprises: submitting a proposed cost-per-click (proposed CPC) for a first keyword advertisement using a first keyword in a keyword advertisement service, which posts keyword advertisement contents in a search result generated in response to a search query submitted to a search engine and charges for the service based on clicking through on the keyword advertisement contents, wherein the keyword advertisement contents are arranged in a plurality of groups in a display of the search result; receiving a first estimated cost for using the keyword advertisement service with regard to the first keyword advertisement for a future period of time for arranging a content of the first keyword advertisement in a first one of the plurality of groups; and submitting a request for subscribing the keyword advertisement service for the first keyword advertisement and for arranging the content of the first keyword advertisement in the first group when including the content of the first keyword advertisement in a search result generated in response to a search query comprising the first keyword.

In the foregoing method, the first estimated cost may be generated by a method comprising: providing historical data of a count of search queries submitted to the search engine and comprising the first keyword; providing historical data of click-through-rates (CTRs) of keyword advertisement, contents of which were or have been arranged in a first one of the plurality of groups; and computing the first estimated cost using the proposed CPC, historical data of a count of search queries and historical data of CTRs. Computing the first estimated cost may be performed by a server of the keyword advertisement service or by a local computer connected to the server via the Internet. Computing the first estimated cost may comprise: processing historical data of the count of search queries to provide an average count of search queries for a past period of time; and processing historical data of click-through-rates (CTRs) to provide an average CTR of the keyword advertisements, the contents of which were or have been arranged in a first one of the plurality of groups. Providing the historical data of CTRs may comprise: identifying keyword advertisements, the contents of which were or have been arranged in the first group for a past period time; and providing a CTR of each of the identified keyword advertisements for the past period of time.

Still in the foregoing method, the method may further comprise: receiving a second estimated cost for using the keyword advertisement service with regard to the first keyword advertisement for the future period of time for arranging the content of the first keyword advertisement in a second one of the plurality of groups. The method may further comprise: receiving a request to pay a proposed prepayment amount computed based on the first estimated cost prior to making the prepayment; and making a prepayment for the keyword advertisement service in response to the request to pay the proposed payment amount.

An aspect of the present invention provides a method and apparatus for calculating an expected charge for an advertisement, which can estimate a reasonable budget when the advertiser registers an advertisement or a telemarketer (TMR) registers an advertisement through a business tool.

Another aspect of the present invention provides a method and apparatus for calculating an expected charge for an advertisement, which calculates the expected charge based on a maximum click cost, an average number of clicks for predetermined period, and an average Click-Through Rate (CTR) of an advertisement region where the advertisement is displayed so as to help an advertiser and TMR to easily and reasonably estimate an advertisement budget.

According to an aspect of the present invention, there is provided a method for calculating an expected charge for an advertisement, the method including receiving a maximum click cost of an advertisement, verifying an average number of clicks for a keyword corresponding to the advertisement, verifying an average CTR of an advertisement region where the advertisement is displayed, and calculating an expected charge of the advertisement based on the maximum click cost, the average number of clicks, and the average CTR.

In an aspect of the present invention, the maximum click cost which indicates a maximum cost per click, is inputted from an advertiser of the advertisement.

Also, in an aspect of the present invention, the verifying of the average number of clicks for the keyword includes verifying an average number of clicks for the keyword for the last n days as the average number of clicks.

Also, in an aspect of the present invention, the verifying of the average CTR of the advertisement region where the advertisement is displayed includes calculating and maintaining a value of an average CTR in each of a plurality of advertisement regions in every predetermined period of time, verifying an advertisement region where the advertisement will be displayed, and verifying the value of the average CTR of the advertisement region as an average CTR of the advertisement region where the advertisement is displayed.

According to another aspect of the present invention, there is provided a system for calculating an expected charge for an advertisement, the system including a maximum click cost reception module to receive a maximum click cost of an advertisement, an average number of clicks verifying module to verify an average number of clicks for a keyword corresponding to the advertisement, an average CTR verifying module to verify a CTR of each advertisement region, and an expected charge calculating module to calculate an expected charge of the advertisement based on the maximum click cost, the average number of clicks, and the average CTR.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates an example of a rough configuration of an expected charge calculating system;

FIG. 2 is a flowchart illustrating a method for calculating an expected charge for an advertisement according to an embodiment of the present invention; and

FIG. 3 is a block diagram illustrating an internal configuration of an expected charge calculating system according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below by referring to the figures.

Generally, ranking of a keyword advertisement is determined depending on a bid amount set by an advertiser, and the keyword advertisement is displayed according to the ranking. When the advertiser wishes to register an advertisement, such as cost-per-click (CPC) advertisement, and the like, the advertiser has difficulty in estimating a reasonable advertisement budget. In particular, in a method where an advertiser deposits a predetermined amount of money and deducts advertising costs from the deposited money, the advertiser has difficulty in estimating a budget.

The present disclosure relates to a method and apparatus for calculating a estimated cost or expected charge, which calculates and provides, when an advertisement is registered, the expected charge for the advertisement in each advertisement region, and thus, embodiments of the present invention enables an advertiser to reasonably estimate an advertisement budget.

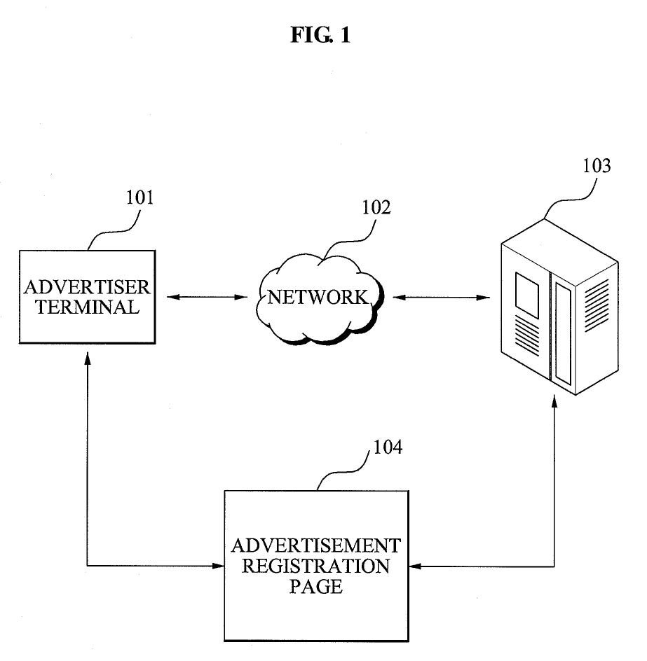

FIG. 1 illustrates an example of a rough configuration of an expected charge calculating system;

The advertiser may access to an expected charge calculating system 103 through an advertiser terminal 101 and network 102. In this instance, the expected charge calculating system 103 may be operated through either interoperation with an advertisement registration system which registers an advertisement or being included in the advertisement registration system.

That is, when the advertiser registers an advertisement through the advertisement registration system, the expected charge calculating system 103 calculates an expected charge for the advertisement and displays the expected charge in an advertisement registration page 104 which the advertisement registration system provides. Thus, the advertiser can estimate a reasonable advertisement budget for the advertisement.

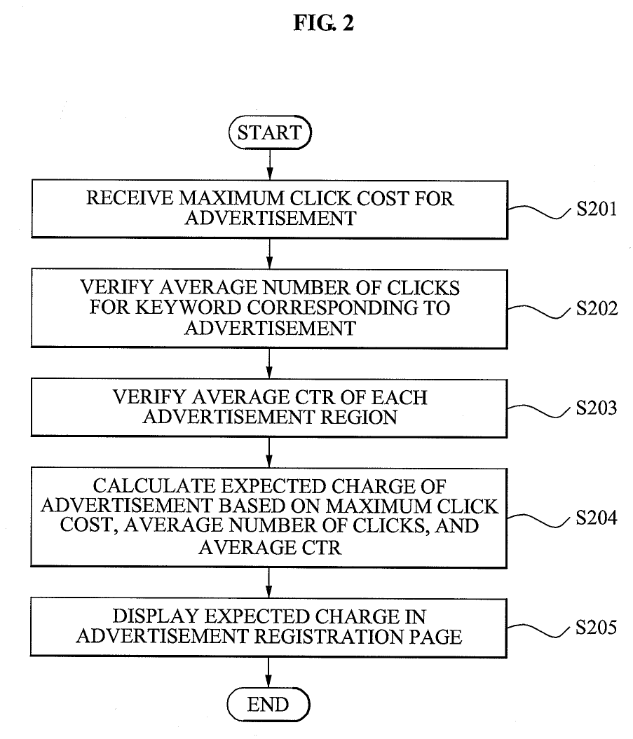

FIG. 2 is a flowchart illustrating a method for calculating an expected charge for an advertisement according to an embodiment of the present invention.

An expected charge calculating system 103 that calculates an expected charge for an advertisement receives a maximum click cost for the advertisement when the advertisement is registered in operation S201. In this instance, the maximum click cost indicates a maximum cost per a click, which is inputted from an advertiser of the advertisement.

The expected charge calculating system 103 verifies an average number of searches or clicks for a keyword corresponding to the advertisement in operations S202. In this instance, in order to verify the average number of clicks for the keyword, the expected charge calculating system 103 may verify an average number of clicks for the keyword for the last n days as the average number of clicks. In one embodiment, the average number may be a daily average of the number of searches using the keyword in a week, which can be obtained by dividing the number of searches by 7 days. In certain embodiments, the average number may be a bi-daily average, a weekly average, a bi-weekly average, a monthly average, a quarterly average, or an hourly average.

In one embodiment, two or more groups of keyword advertisements are listed in a search result. Different locations or regions in a search result are assigned to the groups of keyword advertisements, respectively. This configuration of the search result may cause differences of click through rates (CTRs) between the groups of keyword advertisements.

In one embodiment, the expected charge calculating system 103 verifies an average Click Through Rate (CTR) of each advertisement region in operation S203. In this instance, in order to verify the average CTR of each advertisement region, the expected charge calculating system 103 may calculate and maintain a value of an average CTR in each of a plurality of advertisement regions at every predetermined period of time, so as to verify the value of the average CTR as the average CTR in each advertisement region, when the advertisement is registered. For example, the expected charge calculating system 103 verifies CTR of each advertisement region using the previous 20 days and calculates a value of an average in each advertisement region so as to verify the value of the average CTR as the average CTR in each advertisement region.

Also, the expected charge calculating system may further perform verifying an advertisement region where the advertisement is displayed (not illustrated). In this instance, in the verifying of the average CTR in each advertisement region in operation S203, the expected charge calculating system 103 may calculate and maintain a value of an average CTR in each of the plurality of advertisement regions in every predetermined period of time so as to verify the value of the average CTR of the advertisement region where the advertisement is displayed as an average CTR of the advertisement region when the advertisement is registered.

In operation S204, the expected charge calculating system calculates an expected charge of the advertisement based on the maximum click cost, the average number of clicks, and the average CTR. In this instance, to perform the above, the expected charge calculating system 103 may apply an operation of Equation 1 to the maximum click cost, average number of clicks, and average CTR and calculate the expected charge.

expected charge=maximum click cost*average number of clicks*average, [Equation 1]

where the expected charge may be redefined by reflecting a Quality Control (QC) variable, an average CTR value by the keyword, and a CTR variable for an advertisement listing.

The expected charge calculating system 103 displays the expected charge in an advertisement registration page in operation S205. That is, when an advertisement is registered as described in FIG. 1, the expected charge calculating system 103 calculates the expected charge, and adds the calculated expected charge to the advertisement registration page that the advertisement registration system provides, thereby displaying the expected charge or estimated cost to the advertiser of the advertisement. The estimated cost may be an estimate of cost for a day. In other embodiments, the estimated cost may be an estimate of cost for a week, a month, a quarter, or an hour.

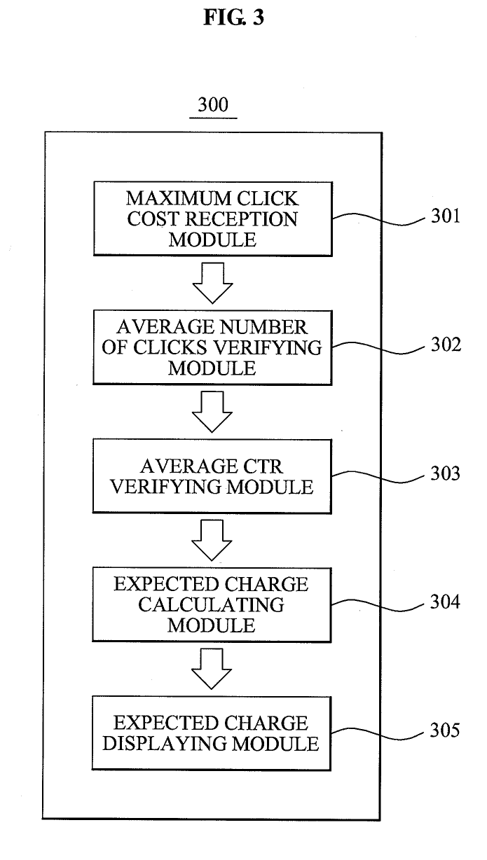

FIG. 3 is a block diagram illustrating an internal configuration of an expected charge calculating system according to an embodiment of the present invention.

In this instance, as shown in FIG. 3, an expected charge calculating system 300 includes a maximum click cost receiving module 301, an average number of clicks verifying module 302, an average CTR verifying module 303, an expected charge calculating module 304, and expected charge displaying module 305.

The maximum click cost receiving module 301 receives a maximum click cost of an advertisement when the advertisement is registered. In this instance, the maximum click cost indicates a maximum cost per a click for the advertisement, which may be inputted by an advertiser of the advertisement.

The average number of clicks verifying module 302 verifies a number of clicks for a keyword corresponding to the advertisement. In this instance, to verify the average number of clicks for the keyword corresponding to the advertisement, the verifying module 302 verifies an average number of clicks for the keyword for the last n days. For example, the average number of clicks verifying module 302 calculates a value of an average number of clicks for the keyword for the last 10 days, and verifies the value of the average as the average number of clicks.

The average CTR verifying module 303 verifies an average CTR in each advertisement region. In this instance, to verify the average CTR in each advertisement region, the average CTR verifying module 303 calculates and maintains a value of the average CTR in each of a plurality of advertisement regions in every predetermined period of time so as to verify the value of the average CTR as the average CTR in each advertisement region, when the advertisement is registered. For example, the average CTR verifying module 303 verifies CTR of each advertisement region using the previous 20 days and calculates a value of an average in each advertisement region so as to verify the value of the average CTR as the average CTR in each advertisement region.

Also, the expected charge calculating system 300 may further include an advertisement region verifying module (not illustrated) that verifies an advertisement region where the advertisement is displayed. In this instance, the average CTR verifying module 303 calculates and maintains a value of the average CTR in each of a plurality of advertisement regions in every predetermined period of time so as to verify a value of the average CTR of the advertisement region where the advertisement is displayed as an average CTR of the advertisement region when the advertisement is registered. That is, the average CTR verifying module 303 calculates and maintains the value of the CTR in each of the plurality of advertisement regions and if the advertisement region verifying module verifies the advertisement region where the advertisement is displayed when registering, the verifying module 303 verifies the value of the CTR for the advertisement region as the average CTR of the advertisement.

The expected charge calculating module 304 calculates an expected charge for the advertisement based on the maximum click cost, average number of clicks, and average CTR. In this instance, to perform the above, the expected charge calculating module 304 may apply an operation of Equation 1 to the maximum click cost, average number of clicks, and average CTR and calculate the expected charge.

The expected charge displaying module 305 displays the expected charge in an advertisement registration page. That is, when an advertisement is registered as described in FIG. 1, the expected charge calculating system 300 calculates the expected charge, and adds the calculated expected charge to the advertisement registration page that the advertisement registration system provides, thereby displaying the expected charge to the advertiser of the advertisement.

As described above, embodiments of the present invention provides a method and apparatus for calculating an expected charge for an advertisement, which enable an advertiser to estimate a reasonable budget when the advertiser registers an advertisement or a telemarketer (TMR) registers an advertisement through a business tool. Also, embodiments of the present invention calculates the expected charge based on a maximum click cost, an average number of clicks for predetermined period, and an average CTR of an advertisement region where the advertisement is displayed, and suggests an expected charge for the advertisement in each advertisement region, so as to help the advertiser and TMR to easily and reasonably estimate an advertisement budget.

Embodiments of the present invention may be recorded computer-readable media including program instructions to implement various operations embodied by a computer. The media may also include, alone or in combination with the program instructions, data files, data structures, and the like. The program instructions may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of running a keyword advertisement service, the method comprising:
providing a keyword advertisement service, which posts keyword advertisement contents in a search result generated in response to a search query submitted to a search engine and charges for the service based on clicking through on the keyword advertisement contents, wherein the keyword advertisement contents are arranged in a plurality of groups in a display of the search result;
receiving, from a potential advertiser, a proposed cost-per-click (proposed CPC) for a first keyword advertisement using a first keyword;
providing historical data of a count of search queries submitted to the search engine and comprising the first keyword;
providing historical data of click-through-rates (CTRs) of keyword advertisement contents arranged in a first one of the plurality of groups; and
computing a first estimated cost for using the keyword advertisement service with regard to the first keyword advertisement for a future period of time, wherein computing uses the proposed CPC, historical data of a count of search queries and historical data of CTRs.

2. The method of claim 1, further comprising:
providing the first estimated cost to the potential advertiser; and
receiving, from the potential advertiser, a request for arranging a content of the first keyword advertisement in the first group in displaying search results in reply to search queries comprising the first keyword.

3. The method of claim 1, further comprising:
requesting, to the potential advertiser, for making a prepayment for using the keyword advertisement service with regard to the first keyword advertisement; and
receiving the prepayment.

4. The method of claim 3, further comprising:
computing a proposed prepayment amount using the first estimated cost; and
providing the potential advertiser with the proposed prepayment amount.

5. The method of claim 1, wherein computing the first estimated cost comprises processing historical data of the count of search queries to provide an average count of search queries for a past period of time.

6. The method of claim 5, wherein the average count is one selected from the group consisting of a daily average, a bi-daily average, a weekly average, a bi-weekly average, a monthly average, a quarterly average, and an hourly average of the count of search queries.

7. The method of claim 1, wherein providing the historical data of CTRs of keyword advertisements arranged in the first group comprises:
identifying keyword advertisements, contents of which were or have been ever arranged in the first group for a past period time; and
providing a CTR of each of the identified keyword advertisements for the past period of time.

8. The method of claim 7, wherein computing the first estimated cost comprises processing the CTRs of the keyword advertisements to provide an average CTR of the identified keyword advertisements.

9. The method of claim 1, further comprising:
rendering the keyword advertisement service with regard to the first keyword advertisement; and
computing a charge for the keyword advertisement service with regard to the first keyword advertisement using a cost-per-click that is equal to or smaller than the proposed CPC.

10. The method of claim 1, further comprising:
rendering the keyword advertisement service with regard to the first keyword advertisement, wherein the content of the first keyword advertisement is arranged in the first group in search results generated in response to search queries comprising the first keyword.

11. The method of claim 1, further comprising:
providing second historical data of click-through-rates (CTRs) of keyword advertisements arranged in a second one of the plurality of groups; and
computing a second estimated cost for using the keyword advertisement service with regard to the first keyword advertisement for a future period of time, wherein computing uses the proposed CPC, historical data of a count of search queries and second historical data of CTRs.

12. The method of claim 11, further comprising:
providing the second estimated cost to the potential advertiser; and
receiving, from the potential advertiser, a request for arranging the content of the first keyword advertisement in the first group in displaying search results in reply to search queries comprising the first keyword.

13. The method of claim 1, wherein the keyword advertisement service has different service fee structures for at least two of the plurality of groups.

14. A method of subscribing a keyword advertisement service, the method comprising:
submitting a proposed cost-per-click (proposed CPC) for a first keyword advertisement using a first keyword in a keyword advertisement service, which posts keyword advertisement contents in a search result generated in response to a search query submitted to a search engine and charges for the service based on clicking through on the keyword advertisement contents, wherein the keyword advertisement contents are arranged in a plurality of groups in a display of the search result;
receiving a first estimated cost for using the keyword advertisement service with regard to the first keyword advertisement for a future period of time for arranging a content of the first keyword advertisement in a first one of the plurality of groups; and
submitting a request for subscribing the keyword advertisement service for the first keyword advertisement and for arranging the content of the first keyword advertisement in the first group when including the content of the first keyword advertisement in a search result generated in response to a search query comprising the first keyword.

15. The method of claim 14, wherein the first estimated cost is generated by a method comprising:
providing historical data of a count of search queries submitted to the search engine and comprising the first keyword;
providing historical data of click-through-rates (CTRs) of keyword advertisement, contents of which were or have been arranged in a first one of the plurality of groups; and
computing the first estimated cost using the proposed CPC, historical data of a count of search queries and historical data of CTRs.

16. The method of claim 15, wherein computing the first estimated cost is performed by a server of the keyword advertisement service or by a local computer connected to the server via the Internet.

17. The method of claim 15, wherein computing the first estimated cost comprises:
processing historical data of the count of search queries to provide an average count of search queries for a past period of time; and
processing historical data of click-through-rates (CTRs) to provide an average CTR of the keyword advertisements, the contents of which were or have been arranged in a first one of the plurality of groups.

18. The method of claim 17, wherein providing the historical data of CTRs comprises:
identifying keyword advertisements, the contents of which were or have been arranged in the first group for a past period time; and
providing a CTR of each of the identified keyword advertisements for the past period of time.

19. The method of claim 14, further comprising:
receiving a second estimated cost for using the keyword advertisement service with regard to the first keyword advertisement for the future period of time for arranging the content of the first keyword advertisement in a second one of the plurality of groups.

20. The method of claim 14, further comprising:
receiving a request to pay a proposed prepayment amount computed based on the first estimated cost prior to making the prepayment; and
making a prepayment for the keyword advertisement service in response to the request to pay the proposed payment amount.
